(19) United States
(12) Patent Application Publication
(10) Pub. No.: US 2009/0042153 A1
(43) Pub. Date: Feb. 12, 2009

(54) Liquid fuel composition for a lamp with a colored flame

(76) Inventors: Harry Ronen, Rishon Le-Zion (IL); Ronen Yakobi, Rishon Le-Zion (IL)

Correspondence Address: BROWDY AND NEIMARK, P.L.L.C.;624 NINTH STREET, NW, SUITE 300, WASHINGTON, DC, 20001-5303, US

(21) Appl. No.: 12/216,666

(22) Filed: Jul. 9, 2008

Related U.S. Application Data
(60) Provisional application No. 60/948,526, filed on Jul. 9, 2007.

(51) Int. Cl. F23D 3/02; F23D 3/18; F21V 37/00; C10L 1/18

(52) U.S. Cl. 431/126; 431/4; 431/320; 44/445

(57) ABSTRACT

A liquid fuel composition for a lamp for producing a colored flame is provided comprising: (a) a liquid fuel consisting substantially of ethylene glycol, and (b) a flame coloring agent such as boric acid or a metal compound capable of producing a flame of a determined color. Also provided are an oil lamp comprising at least one chamber containing the liquid fuel composition, with a pouring hole and one or more nozzles, and one or more wicks, each wick placed over the one or more nozzles and extending into the liquid composition; and kits for producing such oil lamps.

### FIELD OF THE INVENTION

The present invention relates to liquid fuel compositions for lamps that burn with an improved, long lasting and stable colored flame, to lamps containing such liquid fuel and to kits for producing such fuel-containing lamps.

### BACKGROUND OF THE INVENTION

Oil lamps, used for thousands of years to produce light, are vessels containing a fuel combustion source and one or more wicks soaked into the fuel. The fuel is drawn up the wick by capillary forces and, when ignited, produces illumination from a flame at the end of the wick.

Contrary to candles, in which the fuel is solid, usually some form of wax, the fuel in the oil lamp is liquid. Until the 19^{th} century, olive oil was the main fuel in the Mediterranean countries, although other oils from animal or vegetal original were also used. In the 19^{th} century, kerosene or paraffin was more common in oil lamps. The wick was traditionally made of different materials including linen, flax, papyrus and the like. The wick's thickness is important: thin wicks burn more slowly than thick wicks, but the thickness does not really affect the size of the flame. The flame of an oil lamp is usually of a yellow color.

European Patent Application No. 1380628 describes a colored flame candle comprising a primary combustion agent, a higher fatty acid amide, a higher fatty acid triglyceride, a color-forming agent based on organic or inorganic salts, a perfume and a pigment.

U.S. Pat. No. 5,127,922 discloses a candle capable of producing a colored flame, which consists of a protective shell made of a non-charring thermoplastic polyolefin, a fire retardant added to the shell, a fuel contained within the shell comprising polyoxymethylene, optionally a binder and a solvent, and a coloring agent selected from an inorganic salt, an inorganic oxide, a carboxylic acid salt or an organic complex of a metal selected from Li, B, Na, Ca, Cu, K, Sr, In, or Ba. A wick is not required in the candle.

U.S. Pat. No. 6,752,622 discloses a liquid composition for a lamp comprising a liquid solvent composed substantially of propylene glycol, a metal salt at least in part dissolved in the solvent, and hydrochloric acid, wherein the solvent and the metal salt are adapted to, during use, to migrate through a wick that is in contact with the composition, and the composition, when absorbed by the wick, is adapted to burn with a color different from the flame of the solvent burning in the absence of the metal salt or from the color of the flame of conventional lamps or candles, and wherein the composition is a liquid at or near room temperature. The solvent may be mixed with a simple alcohol. One of the disadvantages of such a lamp is that the fuel consists of propylene glycol, a relatively high viscous liquid, which may have difficulties in the capillary diffusion up a wick. In effect, such difficulties in diffusion of the combustion liquid into and up the wick are reflected in instability of the flame size and frequent flame choking.

### SUMMARY OF THE INVENTION

It is an object of the present invention to provide a liquid fuel composition for oil lamps capable of producing a steady, colored flame.

It is another object of the present invention to provide oil lamps capable of producing steady, colored flame which exhibit improved flame stability, no spontaneous ignition and self extinguishing properties of the flame upon liquid spill and accidental damage of the lamp.

It is a further object of the present invention to provide such colored flame oil lamps further having a container for dispersing a pleasant scent such as a fragrance into the environment, thus covering two functions suitable for festive occasions and ceremonies.

In one aspect, the present invention relates to a liquid fuel composition for use in an oil lamp capable of producing a colored flame, comprising: (a) a liquid fuel consisting substantially of ethylene glycol, and (b) a flame coloring agent capable of producing a flame of a determined color.

In another aspect, the present invention relates to an oil lamp capable of producing a colored flame, comprising:
(i) a chamber with a pouring hole and one or more nozzles;
(ii) a liquid composition within said chamber comprising: (a) a liquid fuel consisting substantially of ethylene glycol, and (b) a flame coloring agent capable of producing a flame of a determined color; and
(iii) one or more wicks, wherein each wick is placed over the one or more nozzles and extends into the liquid composition;
whereby ignition of the one or more wicks produces one or more colored flames corresponding to the color produced by the flame coloring agent.

In one embodiment, the invention relates to such an oil lamp further comprising a container for dispersing a scent adaptable to the oil lamp, the container comprising a central support tube having one end extending out of the container and adapted for being inserted into the oil lamp, the central tube further being adapted for containing a wick to be inserted into the oil the lamp and immersed in a liquid fuel composition inside the oil lamp, while the other end of the wick extends outside the container, the central support tube being surrounded inside the container by a wax material containing a fragrance, whereby when the wick burns, the heat generated by the flame heats the central tube and thus heating the wax material resulting in diffusion of the fragrance in the environment. The wick is isolated from the wax material by the central tube, and is thus never in direct contact with the scented was material. Alternatively, the wax material can be replaced with fragrance dispensing liquid such as an essential oil.

In a further aspect, the invention relates to a kit for producing an oil lamp capable of producing a colored flame as disclosed herein, comprising:
(i) one or more chambers, each chamber with a pouring hole and one or more nozzles, adapted to contain a liquid fuel and one or more wicks;
(ii) a reservoir comprising a liquid composition comprising: (a) a liquid fuel consisting substantially of ethylene glycol, and (b) a flame coloring agent capable of producing a flame of a determined color; and
(iii) a package of wicks adapted for use in said oil lamp.

In one embodiment, the kit further comprises a container for dispersion of a pleasant scent such as a fragrance, the container comprising a central tube surrounded by a wax material containing a fragrance and a wick extending from the outside through the central tube to be immersed in the liquid fuel of an oil lamp.

### BRIEF DESCRIPTION OF THE FIGURES

The patent or application file contains at least one drawing executed in color. Copies of this patent or patent application publication with color drawings will be provided by the Office upon request and payment of the necessary fee.

FIG. 1 depicts an oil lamp with a typical vessel design according to one embodiment of the invention.

FIG. 2 is a photo of three colored flame oil lamps with a typical vessel design according to one embodiment, showing an oil lamp with a green flame (left), a lamp with a red flame (center), and a lamp with a gold flame (right).

FIG. 3 depicts a typical oil lamp filled with a liquid fuel combined with a scent diffusing device, according to one embodiment of the invention.

FIG. 4 depicts a typical oil lamp combined with a scent diffusing device comprising wax balls, according to one embodiment of the invention.

FIG. 5 is a photo of four burning oil lamps of the invention with (from left to right) green, yellow, red and blue flames.

### DETAILED DESCRIPTION OF THE INVENTION

The liquid fuel composition of the invention comprises: (a) a liquid fuel consisting substantially of ethylene glycol, and (b) a flame coloring agent capable of producing a flame of a determined color.

The colored flame according to the invention is produced by burning a flame coloring agent capable of producing a flame of a determined color. The flame coloring agent may be any compound or mixture of compounds capable of producing a colored flame such as, but not limited to, boric acid or a metal compound selected from the group consisting of an inorganic metal salt, an inorganic metal hydroxide, an organic metal salt, and an organic metal complex.

In preferred embodiments, the flame coloring agent is boric acid or an inorganic metal salt or hydroxide such as, but not limited to, sodium chloride, lithium chloride, lithium hydroxide, strontium chloride, copper sulfate, sodium borate, copper (II) chloride, copper (II) oxide, potassium chloride, potassium hydroxide and rubidium chloride. The metal salts chosen should not be toxic and should not produce harmful byproducts when burned such as permanganates, nitrates and chlorates.

The fuel according to the invention consists of ethylene glycol. It is a good solvent for many metal salts and burns with colorless flame. Therefore, there is no color interference between the flames originated from the vaporized metal salts and the burned combustion liquid. Ethylene glycol has the appropriate viscosity (18 CSt@20° C.), to keep a steady transport of fuel through the wick. This uniform transport is reflected in a steady and long lasting colored flame. From safety perspectives, ethylene glycol has no spontaneous ignition if spilled while the lamp is burning.

Contrary to ethylene glycol, propylene glycol, disclosed as the preferable fuel in U.S. Pat. No. 6,752,622, is characterized by a relatively high viscosity (54 cSt@20° C.), which adversely affects the transport of the liquid up through the wick. Therefore, the rate of transport of the fuel is low and not steady. The dissolved metal salt is incompletely vaporized and precipitates on the wick surface. Thus, choking of the flame when using propylene glycol is evident within a very short time. In order to solve the transport problem through the wick created by propylene glycol it is required to add a relatively large amount of alcohol, such as methanol or ethanol, in order to reduce the fuel viscosity and to increase the energy of the flame upon burning. The disadvantage of this solution is the high flammability of the mixture and the loss of the pure color of the flame due to the interference by the burned alcohol yellow hue. The superiority of the compositions of the present invention comprising ethylene glycol vis-à-vis the prior art compositions comprising propylene glycol is shown in the comparative Example 7 herein below.

The liquid fuel composition of the invention may further comprise methanol, citric acid, hydrochloric acid, water, a bitter additive, a food coloring agent matching the color of the flame, a food coloring agent with a different color than the color of the flame, or a combination thereof.

The use of small quantities of methanol is advantageous since it decreases both the viscosity and the ignition temperature of ethylene glycol, dissolves many metal salts and prevents their recrystallization in the ethylene glycol composition. Although ethanol may be used as well for this purpose, methanol is preferred according to the invention. Contrary to the proportion that would be needed with propylene glycol, the amount of methanol in the fuel composition of the present invention is in the range from 7.0% (v/v) to 12%, preferably 7.4, 7.7, 8.8 or 11.4% (v/v).

In another embodiment, citric acid is used in the fuel composition instead of methanol.

The liquid composition may further comprise hydrochloric acid, preferably within the range 2.5-3% (v/v), more preferably about 2.8-2.95% (v/v), of concentrated hydrochloric acid.

The liquid composition may also comprise a small amount of water, for example, 2.5-3.0% (v/v), preferably 2.9-3.0%.

In one preferred embodiment, a food coloring agent that matches the color of the flame produced is added to the liquid composition, thus obtaining an advantageous visual effect, particularly when the chamber of the oil lamp is made of a transparent material such as glass.

If a yellow colored flame is desired, sodium salts can be used such as sodium carbonate or sodium chloride. In one preferred embodiment, the salt is sodium chloride and the liquid composition comprises from about 0.0006 to about 0.0009 g, preferably 0.00067 g sodium chloride per ml ethylene glycol. This composition also preferably contains about 3% (v/v) water and about 7.47% (v/v) methanol. If desired, a yellow food colorant such as E100, E101 or E105 is added to the composition.

When a red colored flame is desired, lithium or strontium salts can be used such as lithium chloride or strontium chloride or lithium hydroxide. In one preferred embodiment, the salt is lithium chloride and the liquid composition comprises from about 0.003 to about 0.006 g, preferably 0.0035 g lithium chloride per ml ethylene glycol. This composition also preferably contains about 2.9% (v/v) hydrochloric acid and about 11.45% (v/v) methanol. If desired, a red food colorant such as E129 is added to the composition.

When a green colored flame is desired, copper sulfate, sodium borate or boric acid can be used. In one preferred embodiment, the compound is boric acid and the liquid composition comprises from about 0.04 to about 0.08 g, preferably 0.042 g boric acid per ml ethylene glycol. This composition also preferably contains about 7.70% (v/v) methanol and no water or hydrochloric acid. If desired, a green food colorant such as E140 is added to the composition.

When a blue colored flame is desired, copper (ii) oxide or copper hydroxide or copper (II) salts such as copper (II) chloride can be used. In one preferred embodiment, the liquid composition comprises from about 0.004 to about 0.006 g, preferably 0.0042 g cupric chloride per ml ethylene glycol. This composition also preferably contains about 2.9% (v/v) hydrochloric acid and about 8.8% (v/v) methanol. If desired, a blue food colorant such as E133 is added to the composition.

When a purple colored flame is desired, potassium hydroxide or potassium or rubidium salts such as potassium chloride or rubidium chloride can be used. E163 can be used as a purple food coloring agent.

Ethylene glycol is a very sweet and toxic compound and it is recommended to add a bitter additive to ethylene glycol in order to prevent its ingestion by humans or animals. In a preferred embodiment of the invention, the bitter additive added to the fuel composition is denatonium benzoate, commercially available under the registered trademarks Bitrex® and Aversion®. Denatonium benzoate is the world's most bitter substance. Use of denatonium benzoate ranges from 20-500 ppm (0.002% to 0.050%) in most consumer products. It is a safety additive used in household automotive and garden products and is also an animal repellent We have tested Bitrex and observed that it does not affect the performance of the fuel composition of the invention, its appearance or fragrance at the low concentrations used to be effective.

In another aspect, the invention relates to an oil lamp comprising a chamber for containing the liquid composition. The chamber may be made of any suitable material such as terra cotta, clay, thermoresistant plastic, metal, e.g., brass or bronze, ceramic and the like, and may be artistically decorated or not. In one preferred embodiment, the chamber is made of a transparent material, more preferably transparent glass, most preferably Pyrex.

The oil lamp chamber may be of any suitable form, preferably round, and it may come with or without one or more handles. The chamber has one or multiple pouring holes, preferably a sole one, through which the oil or liquid fuel composition is poured into the chamber. It may comprise one or more nozzles, preferably a sole nozzle, through which the wick immersed into the liquid composition inside the chamber exits outside and produces the colored flame, when ignited. The nozzle may be located at any suitable place on the chamber, for example, on the side or preferably on the top at the center or at the corner of the chamber. Alternatively, the oil lamp may contain multiple chambers, thus producing multiple flames in one or more colors.

The wick preferably has a high porosity and may be composed of any suitable natural or synthetic material such as braided cotton or, preferably, braided glass fiber. The wick preferably has a length of 5-15 cm. When immersed in the liquid fuel of the oil lamp and lighted, such a wick can be used until the liquid fuel in the oil lamp is exhausted, and the wick does not need to be replaced in the middle of the burning process.

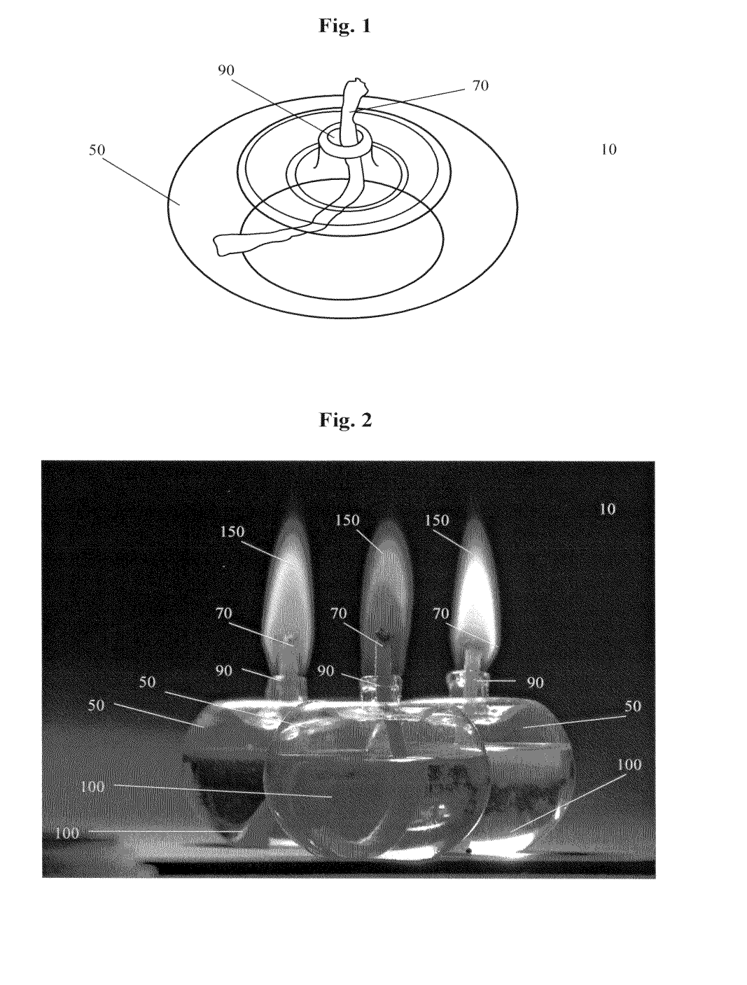

FIG. 1 depicts a typical oil lamp (10) of the invention with a typical vessel (50) design according to one embodiment. A wick (70) is inserted into the vessel (50) through an opening (90) such that part of the wick (70) remains outside the vessel (50).

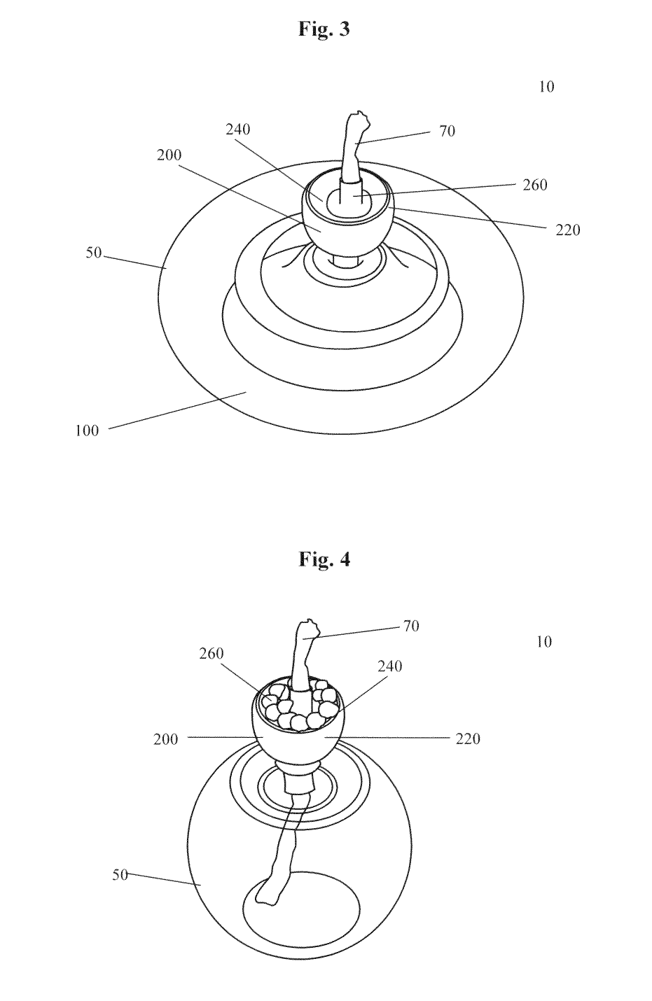

FIG. 2 is a photo of three typical colored flame oil lamps (10) of the invention with a typical vessel (50) design according to one embodiment, showing oil lamps (50) containing liquid fuel compositions comprising a food coloring agent matching the color of the flame (100). A wick (70) is immersed in the liquid fuel composition (100) and extends outside the vessel (50) through an opening (90). Three color flames (150) are shown: green (left), red (center), and yellow (right).

FIG. 3 depicts a typical combination of an oil lamp (10) and a scent diffusing device (200). The oil lamp (10) is filled with a fuel composition (100). The scent diffusing device (200) comprises a semi-round container (220), to contain the scented wax (240) material and a central tube (260) through which the wick (70) is inserted into the vessel (50).

FIG. 4 depicts a typical oil lamp (10) combined with a scent diffusing device (200) comprising scented wax (240) in the form of wax balls, according to one embodiment of the invention.

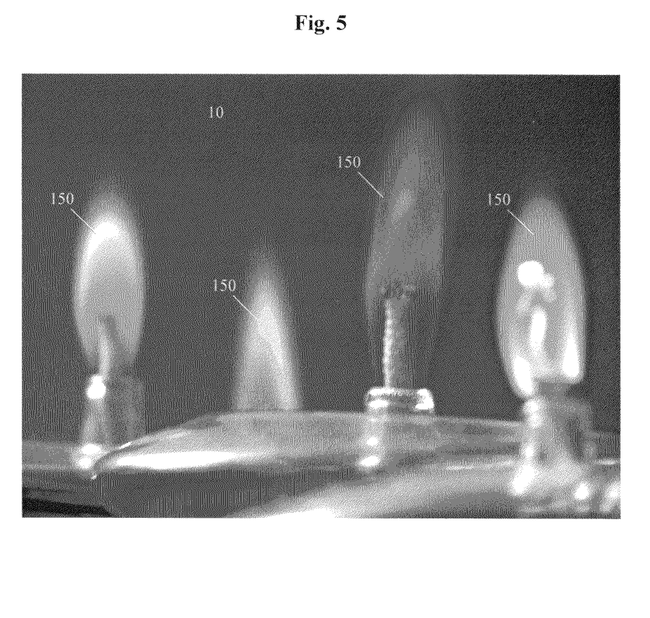

FIG. 5 is a photo of four burning oil lamps (10) of the invention showing (from left to right) green, yellow, red and blue color flames (150).

The oil lamp (10) of the invention is particularly advantageous for use in festive occasions, in festive halls, restaurants and the like. For these purposes, the invention also provides the option of buying kits comprising one or more chambers, a reservoir containing the liquid fuel composition (100) and a package of wicks (70) or only the liquid fuel composition (100). This will enable the user to assemble the oil lamps (10) according to the invention and to refill the chamber with the liquid fuel composition (100) and a new wick (70) when necessary.

In one embodiment, the wick (70) exits through an opening in the vessel (50). The vessel (50) may include a support tube located at the opening (90). The support tube may be composed of a material that can tolerate the heat of the flame, and can be made of glass, metal, ceramic or plastic materials. The wick (70) may pass though the support tube to the exterior of the vessel (50). In one embodiment, the wick (70) may extend from about 2 mm to 30 mm beyond the support tube.

In one embodiment, the scent device component is a scent diffuser (200) as depicted in FIG. 3 and FIG. 4 made of a semi round glass container (220), preferably a heat and chemical resistant glass such as Pyrex, to contain the scented waxy material (240). The semi round glass container (220) is combined with a central support tube (260).

The purpose of this central support tube (260) is two-fold: one is to facilitate the mechanical stabilization of the scent device (200) when combined with the colored flame oil lamp (10). The central support tube (260) is passed through the lamp opening (90) and thus stabilizes the construction of the scented oil lamp (10). The second purpose of the central support tube (260) is to contain and support the wick (70) within the oil lamp (10). The wick (70) may pass through the central support tube (260) from the bottom of the oil vessel (50) to the exterior of the oil lamp (70). The central support tube (260) may support both portions of the wicks (70). The portion that extends beyond the oil lamp (10) and the other portion that soaks in the liquid fuel composition (100). The portion of the wick (70) that extends beyond the oil lamp (10) determines the position of the flame and the distance between the flame and the scented waxy material.

In one embodiment, the scented wax material (240) is made of a combination of wax or beeswax or paraffin and a perfume (fragrance). Preferably, the perfume is 100% pure and not diluted in water or alcohol. In order to produce a strong scented effect, a composition of at least 75% perfume and 25% wax should be used. The resulting composition will be a very soft scented wax. This ratio can also be expressed as 1.75 milliliter perfume for every 0.5 gram of wax.

In order to produce a good (but not so strong) scented effect, a composition of at least 50% perfume and 50% wax should be used. This ratio can also be expressed as 2 milliliter perfume for every 2 gram of wax.

In order to produce a mild scented effect, a composition of at least 25% perfume and 75% wax should be used. The resulting composition will be a very hard scented wax. This ratio can also be expressed as 0.5 milliliter perfume for every 2.5 gram of wax.

Examples of popular scents in the market that can be used in accordance with the present invention include, without limitation, lemon, lavender, cinnamon, vanilla, coconut, orange, coffee, rose, apple, pepper, any other scent available in the market, or any combination of one or more scents.

Alternatively, instead of using a scented wax material (240), the same effect can be achieved by placing a few drops of a scented extract on a crena on top of the vessel (50).

The preferred length of the central support tube (260) is within 5 mm to 30 mm inside the lamp opening (90). The preferred range of extension of the wick (70) beyond the support tube is between 2 mm and 30 mm. Increasing the distance that the wick (70) extends outside the vessel (50) will increase the size of the color flame (150) but will also decrease the burning time of the oil lamp (10) since more liquid fuel composition (100) will be consumed.

In another aspect, the invention also relates to a color-flamed torch adapted for typically using outdoors. The torch can be used in festive occasions outdoors such as festivals, weddings and other ceremonies. The larger size vessel (50) should be made of a heat and chemical resistant material such as glass, tin, plastic or clay. The vessel (50) should contain at least 0.5 litters of a liquid fuel composition (100), with braided cotton or braided fiberglass wick (70) of at least 1 to 5 centimeters. If the size of the color flame (150) needs to be increased, then some methanol could be carefully added to the liquid fuel composition (100) before kindling the wick (70).

While embodiments of the invention have been described by way of illustration, it will be apparent that the invention may be carried out with many modifications, variations and adaptations, without departing from its spirit or exceeding the scope of the claims.

The invention will now be illustrated by the following non-limiting Examples.

### EXAMPLES

In the examples below, all compositions were prepared in a volume of about 140 ml. This volume was found to be optimal for a flame of duration of about 4 hours. In the procedure, addition of each of the ingredients was done under stirring and the resulting composition was thoroughly mixed and stored in a closed bottle.

### Example 1

### Preparation of Gold Flame Composition

1.1 A gold/yellow flame producing composition comprising ethylene glycol, methanol, water, and sodium chloride was prepared as follows: sodium chloride (0.080 g) was dissolved in 4 cc cold water and, upon the disappearance of the salt crystals, methanol (10 cc) was added, followed by addition of ethylene glycol (120 cc). If desired, a yellow food colorant such as E100, E101 or E105 (0.001 g) and/or Bitrex (0.030-0.010 g) is added after the ethylene glycol.

1.2 A gold/yellow flame producing composition comprising ethylene glycol, citric acid, water, and sodium chloride was prepared as follows: sodium chloride (0.080 g) along with citric acid (0.010-0.150 g) were dissolved in 4 cc cold water and, upon disappearance of the salt crystals, ethylene glycol (120 cc) was added. If desired, Bitrex (0.030-0.010 g) is dissolved in water along with the sodium chloride and the citric acid and a yellow food colorant such as E100, E101 or E105 (0.001 g) is added after the ethylene glycol.

### Example 2

### Preparation of Red Flame Composition

2.1 A red flame producing composition comprising ethylene glycol, methanol, and lithium chloride was prepared as follows: lithium chloride (0.420 g or 0.310 g) was dissolved in methanol (16 cc or 14 cc, respectively), followed by addition of 120 cc ethylene glycol. Concentrated hydrochloric acid (4 cc) can be carefully added before addition of the ethylene glycol and 0.001 g red food colorant such as E129 can be added after the ethylene glycol.

2.2 A red flame producing composition comprising ethylene glycol, citric acid, water, and lithium chloride was prepared as follows: lithium chloride (0.310 g or 0.310 g) along with citric acid (0.010-0.150 g) were dissolved in 4 cc cold water and, upon the disappearance of the salt crystals, ethylene glycol (120 cc) was added. If desired, Bitrex (0.030-0.010 g) is dissolved in water along with the sodium chloride and the citric acid and 0.001 g red food colorant such as E129 can be added after the ethylene glycol.

### Example 3

### Preparation of Green Flame Composition

3.1 A green flame producing composition comprising ethylene glycol, methanol, and boric acid was prepared as follows: boric acid (5.0 g) was dissolved in 30 cc heated ethylene glycol (60-100° C.) and stirred thoroughly until disappearance of the crystals and the solution becomes transparent. The remaining portion of ethylene glycol (90 cc) was then added, the solution was let to cool down to room temperature and then 10 cc methanol was added. If desired, 0.001 g green food colorant such as E143 can be added after the addition of methanol.

3.2 A green flame producing composition comprising ethylene glycol, citric acid, and boric acid was prepared as follows: boric acid (5.0 g) along with citric acid (0.010-0.150 g) was dissolved in 30 cc ethylene glycol under boiling and stirred thoroughly until disappearance of the crystals and the solution becomes transparent. The remaining portion of ethylene glycol (90 cc) was then added. If desired, Bitrex (0.030-0.010 g) is dissolved along with the boric acid and the citric acid in the 30 cc ethylene glycol and 0.001 g green food colorant such as E143 can be added after the second portion of ethylene glycol.

### Example 4

### Preparation of Blue Flame Composition

4.1 A blue flame producing composition comprising ethylene glycol, methanol, hydrochloric acid and copper (II) chloride was prepared as follows: 0.520 g copper (II) chloride 99% was dissolved in 12 cc methanol and 10 cc concentrated hydrochloric acid was carefully added and mixed thoroughly for about 3 minutes, followed by addition of 120 cc ethylene glycol under stirring. If desired, 0.001 g blue food colorant such as E133 can be added after the addition of ethylene glycol and stirred.

4.2 A blue flame producing composition comprising ethylene glycol, citric acid, hydrochloric acid and copper (II) chloride was prepared as follows: to a mixture of copper (II) chloride 99% (0.500 g) with citric acid (0.010-0.150 g) 4 cc concentrated hydrochloric acid was carefully added and mixed thoroughly for about 3 minutes until all crystals were dissolved, followed by addition of 120 cc ethylene glycol under stirring. If desired, Bitrex (0.030-0.010 g) is mixed along with the copper chloride and the citric acid and 0.001 g blue food colorant such as E133 can be added after the ethylene glycol and stirred.

### Example 5

### Preparation of Purple Flame Composition

A purple flame producing composition comprising a rubidium or potassium salt such as potassium chloride or rubidium chloride is prepared in the same way as in the examples above. For example, a composition comprising ethylene glycol, citric acid, hydrochloric acid and potassium or rubidium salt is prepared as follows: to a mixture of potassium or rubidium salt (0.250 g) with citric acid (0.010-0.150 g) 4 cc concentrated hydrochloric acid is carefully added and mixed thoroughly for about 3 minutes until all crystals are dissolved, followed by addition of 120 cc ethylene glycol under stirring. If desired, Bitrex (0.030-0.010 g) is mixed along with the potassium or rubidium salt and the citric acid and 0.001 g purple food colorant such as E163 can be added after the ethylene glycol and stirred.

### Example 6

### Comparison between Ethylene Glycol and Propylene Glycol as the Combustion Liquid

The green (example 3) and the red (example 2) compositions were prepared both with ethylene glycol and propylene glycol for the purpose of comparison. The results in Table 1 show that the compositions of the invention burn longer (4 hours) than the compositions with propylene glycol (about 2 minutes).

TABLE 1
Comparative results of ethylene vs. propylene glycol as
substantial combustion liquid.

| combustion | | Flame | Flame | |
|---|---|---|---|---|
| liquid | Color | longevity | uniformity | Comments |
| Propylene | Red | ~2 minutes | Flashes of red | The flame is |
| glycol | | | flame with | choked in two |
| | | | yellow aura | minutes and the |
| | | | | wick tip is |
| | | | | coated by black |
| | | | | precipitate |
| | Green | ~2 minutes | | The flame is |
| | | | | choked in two |
| | | | | minutes and the |
| | | | | wick tip is |
| | | | | coated by black |
| | | | | precipitate |
| Ethylene | Red | 4 hrs, till | Uniform, | |
| glycol | | the complete | sharp, | |
| | | consumption | without flashes | |
| | | of the | | |
| | | ethylene glycol | | |
| | Green | 4 hrs, till | Uniform, | |
| | | the complete | sharp, | |
| | | consumption | without flashes | |
| | | of the | | |
| | | ethylene glycol | | |

### Example 7

### Preparation of the Scent Containing Material

For a lamp of the invention with a scent diffuser depicted in FIGS. 3 and 4, paraffin wax or beeswax is heated to above 60° C. until the waxy material (240) is liquefied. The fragrance concentrate and a food colorant are added to the liquefied wax and mixed thoroughly. The mixture is poured quickly into the container (200), preferably a glass container (200), and solidifies upon cooling to room temperature. At the end, the wick (70) is introduced through the central support tube (260) from one side, existing on the other side of the tube to be later inserted into the combustion fuel liquid (100) of the vessel (50). The wick (70) is never in contact with the scented waxy material (240) as it may change the color of the flame.

1. A liquid fuel composition for a lamp for producing a colored flame, comprising: (a) a liquid fuel consisting substantially of ethylene glycol, and (b) a flame coloring agent capable of producing a flame of a determined color.

2. The liquid fuel composition according to claim 1, wherein said flame coloring agent is boric acid or a metal compound selected from the group consisting of an inorganic metal salt, an inorganic metal hydroxide, an organic metal salt, and an organic metal complex.

3. The liquid fuel composition according to claim 2, wherein said metal compound is selected from the group consisting of sodium chloride, lithium chloride, lithium hydroxide, strontium chloride, copper sulfate, sodium borate, copper (II) chloride, copper (II) oxide, potassium chloride, potassium hydroxide and rubidium chloride.

4. The liquid fuel composition according to claim 1, further comprising methanol, citric acid, hydrochloric acid, water, or a combination thereof.

5. The liquid fuel composition according to claim 4, further comprising a bitter additive, a food coloring agent, or both.

6. An oil lamp capable of producing a colored flame comprising:
(i) at least one chamber with a pouring hole and one or more nozzles;
(ii) a liquid composition within said chamber comprising: (a) a liquid fuel consisting substantially of ethylene glycol; and (b) a flame coloring agent capable of producing a flame of a determined color; and
(iii) one or more wicks, wherein each wick is placed over the one or more nozzles and extends into the liquid composition;
whereby ignition of the one or more wicks produces one or more colored flames corresponding to the color produced by the flame coloring agent.

7. The oil lamp according to claim 6, wherein said chamber is made of clay or of a transparent material such as glass.

8. The oil lamp according to claim 6, wherein said chamber comprises a sole nozzle.

9. The oil lamp according to claim 6, wherein said flame coloring agent is boric acid or a metal compound selected from the group consisting of an inorganic metal salt, an inorganic metal hydroxide, an organic metal salt, and an organic metal complex.

10. The oil lamp according to claim 9, wherein said metal compound is selected from the group consisting of sodium chloride, lithium chloride, lithium hydroxide, strontium chloride, copper sulfate, sodium borate, copper (II) chloride, copper (II) oxide, potassium chloride, potassium hydroxide and rubidium chloride.

11. The oil lamp according to claim 6, further comprising methanol, citric acid, hydrochloric acid, water, or a combination thereof.

12. The oil lamp according to claim 11, further comprising a bitter additive, a food coloring agent matching the color of the flame, or both.

13. The oil lamp according to claim 6, further comprising a scent dispenser for diffusing a scent optionally comprising a glass container for dispersing a scent adaptable to the oil lamp, the container comprising a central support tube having one end extending out of the container and adapted for being inserted into the oil lamp, the central tube further being adapted for containing a wick to be inserted into the oil the lamp and immersed in a liquid fuel composition inside the oil lamp, while the other end of the wick extends outside the container, the central support tube being surrounded inside the container by a wax material containing a fragrance, whereby when the wick burns, the heat generated by the flame heats the central tube and thus heating the wax material resulting in diffusion of the fragrance in the environment.

14. The oil lamp according to claim 13, wherein said scent dispenser for diffusing a scent comprise scented extract drops placed in a crena in said oil lamp such that when the wick burns, the heat generated by the flame heats the crena and thus heats the extract drops resulting in diffusion of the fragrance in the environment.

15. A kit for producing an oil lamp according to claim 6, comprising:
(i) one or more chambers, each chamber with a pouring hole and one or more nozzles, adapted to contain a liquid fuel and one or more wicks;
(ii) a reservoir comprising a liquid composition comprising: (a) a liquid fuel consisting substantially of ethylene glycol; and (b) a flame coloring agent capable of producing a flame of a determined color; and
(iii) a package of wicks adapted for use in said oil lamp.

16. The kit according to claim 15, wherein the chamber of the oil lamp is made of clay or of a transparent material such as glass.

17. The kit according to claim 16, wherein said chamber comprises a sole nozzle.

18. The kit according to claim 15, wherein said flame coloring agent is boric acid or a metal compound selected from the group consisting of an inorganic metal salt, an inorganic metal hydroxide, an organic metal salt, and an organic metal complex.

19. The kit according to claim 18, wherein said metal compound is selected from the group consisting of sodium chloride, lithium chloride, lithium hydroxide, strontium chloride, copper sulfate, sodium borate, copper (II) chloride, copper (II) oxide, potassium chloride, potassium hydroxide and rubidium chloride.

20. The kit according to claim 15, further comprising methanol, citric acid, hydrochloric acid, water, or a combination thereof.

21. The kit according to claim 15, further comprising a bitter additive, a food coloring agent matching the color of the flame, or both.

22. The kit according to claim 15, further comprising a scent device adaptable to the chamber of the oil lamp and scented waxy material.

23. A torch capable of producing a colored flame comprising:
(i) at least one chamber with a pouring hole and one or more nozzles;
(ii) a liquid composition within said chamber comprising: (a) a liquid fuel consisting substantially of ethylene glycol; and (b) a flame coloring agent capable of producing a flame of a determined color; and
(iii) one or more wicks, wherein each wick is placed over the one or more nozzles and extends into the liquid composition;
whereby ignition of the one or more wicks produces one or more colored flames corresponding to the color produced by the flame coloring agent.
